(19) United States
(12) Patent Application Publication
(10) Pub. No.: US 2015/0220293 A1
(43) Pub. Date: Aug. 6, 2015

(54) SYSTEMS AND METHODS FOR PERFORMING GRAPHICS PROCESSING

(71) Applicant: LEAP Computing, Inc., Austin, TX (US)

(72) Inventor: Frank Joshua Alexander Nataros, Austin, TX (US)

(21) Appl. No.: 14/610,155

(22) Filed: Jan. 30, 2015

Related U.S. Application Data
(63) Continuation-in-part of application No. 61/933,895, filed on Jan. 31, 2014.

(51) Int. Cl. G06F 3/14; G06F 13/16; G06T 1/20

(52) U.S. Cl. CPC G06F 3/14; G06T 1/20; G06F 13/1689; G06F 2213/0024; G06F 2213/0026

(57) ABSTRACT

A method for performing graphic processing that includes obtaining graphics data with a modular computing card, the modular computing card comprising a processing unit, a PCI-Express interface, and a network interface means, wherein the modular computing card is configured for operating within a host computer via the PCI-Express interface, and also configured for operating as a stand-alone computing card via power through the PCI-Express interface. The method further comprising executing predetermined rules employed by a program, thereby determining a graphics data processing means to be actuated for processing the graphics data, wherein the graphics data processing means is one of the processing unit or an external graphics data processing means communicably coupled to the modular computing card via the network interface means. The method additionally comprising actuating, according to the predetermined rules, the graphics data processing means for receiving and processing the graphics data, and outputting the processed graphics via a display means communicably coupled to the modular computing card.

### STATEMENT OF PRIORITY

The present application is a continuation-in-part and claims priority to U.S. Provisional Application No. 61/933,895, titled “APU Cloud Accelerator” and filed Jan. 31, 2014.

### TECHNICAL FIELD

The present disclosure relates to systems and method for performing graphics processing and, in particular, a modular computing card configurable to operate within a host or as a stand-alone computing card which reduces graphics resources consumption.

### BACKGROUND

In today's computing environments, demand for performance is constantly increasing. In particular, as video and image technology advances, larger and more detailed videos and pictures are generated, thereby producing an increased amount of data to be processed. Resulting therefrom, an increased bandwidth and processing power is required to quickly transfer and render such data.

A computer is typically comprised of, among other hardware, a motherboard arranged within a chassis which holds a central processing unit (CPU), both of which (the motherboard and CPU) act as a central command for running programs and controlling other resources such as local memory, executing programs, and displaying the program output. Some programs require great video or image processing power. This could be due to a large or high quality picture, or could similarly be the result of a high quality video being played. While motherboards typically include a cheap default video chipset, and some central processors also include an integrated graphics processing unit, many consumers find themselves buying a video card specifically manufactured with specialized and dedicated hardware to offload the handling of these large pictures and videos from the motherboard (or central processor) as the video card can perform the processing exponentially faster.

At least one problem with this solution is cost. In addition to buying the computer, the dedicated graphics card is an additional expensive purchase. Moreover, as technology quickly advances, the graphics card will need to be replaced, possibly quite often.

Another problem with this solution is the lack of efficient resource use and flexibility. Typically, upon installation of a graphics card into a computer, all graphics rendering is then diverted from the default motherboard chipset and central processor to the graphics card. However, this fails to utilize the default resources for less complex graphics calls which the motherboard may be capable of processing. Additionally, the user is limited to the processing capabilities and memory of the graphics card, as the graphics card does not have access to additional external resources.

Moreover, the graphics card form factor is typically in a PCI-Express (PCI-E) form factor due to the PCI-E bus having significant bandwidth capable of handling the high data throughput associated with some graphics processing. However, with this form factor, the graphics card is required to be configured within a host computer, as it cannot operate as a stand-alone device due to failing to have the additional required hardware (e.g., the motherboard, CPU, RAM, Operating System, etc.).

Accordingly, an improved system with capabilities to access external graphics processing resources, yet flexible enough to be configured in a host computer to control graphics processing therein remains highly desirable.

### SUMMARY OF THE INVENTION

The present disclosure introduces various illustrative embodiments for performing graphics processing.

It is an object of the present disclosure to provide a method for performing graphic processing that includes obtaining graphics data with a modular computing card, the modular computing card comprising a processing unit, a PCI-Express interface, and a network interface means, wherein the modular computing card is configured for operating within a host computer via the PCI-Express interface, and also configured for operating as a stand-alone computing card via power through the PCI-Express interface. The method further comprises executing predetermined rules employed by a program, thereby determining a graphics data processing means to be actuated for processing the graphics data, wherein the graphics data processing means is one of the processing unit or an external graphics data processing means communicably coupled to the modular computing card via the network interface means. The method additionally comprises actuating, according to the predetermined rules, the graphics data processing means for receiving and processing the graphics data, and outputting the processed graphics via a display means communicably coupled to the modular computing card.

It is another object of the present disclosure to provide a system for performing graphics processing that include a modular computing card configured to obtain graphics data and comprising a processing unit, a PCI-Express interface, and a network interface means, wherein the modular computing card is configured for operating within a host computer via the PCI-Express interface, and also configured for operating as a stand-alone computing card via power through the PCI-Express interface. The system further includes a graphics data processing means, wherein the graphics data processing means is one of the processing unit or an external graphics data processing means communicably coupled to the modular computing card via the network interface means. The system additionally comprises a program configured to execute predetermined rules, thereby determining the graphics data processing means to be actuated for processing the graphics data, and a display means communicably coupled to the modular computing card for outputting the processed graphics.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and the benefit of this disclosure.

FIG. 1A is an angled view of a modular computing card as configured for operating within a host computer, according to one or more embodiments.

FIG. 1B is a schematic view of the modular computing card as configured for operating as a stand-alone computing card, according to one or more embodiments.

FIG. 2 is an enlarged schematic view of the modular computing card, according to one or more embodiments.

FIG. 3 is a block diagram of the modular computing card components, according to one or more embodiments.

FIG. 4 is a flow diagram of an illustrative method for performing graphics processing, according to one or more embodiments.

### DETAILED DESCRIPTION

The present disclosure relates to systems and method for performing graphics processing and, in particular, a modular computing card configurable to operate within a host or as a stand-alone computing card which reduces graphics resources consumption.

An illustrative embodiment includes performing graphic processing that includes obtaining graphics data with a modular computing card, the modular computing card comprising a processing unit, a PCI-Express interface, and a network interface means, wherein the modular computing card is configured for operating within a host computer via the PCI-Express interface, and also configured for operating as a stand-alone computing card via power through the PCI-Express interface. The method further comprises executing predetermined rules employed by a program, thereby determining a graphics data processing means to be actuated for processing the graphics data, wherein the graphics data processing means is one of the processing unit or an external graphics data processing means communicably coupled to the modular computing card via the network interface means. The method additionally comprises actuating, according to the predetermined rules, the graphics data processing means for receiving and processing the graphics data, and outputting the processed graphics via a display means communicably coupled to the modular computing card.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

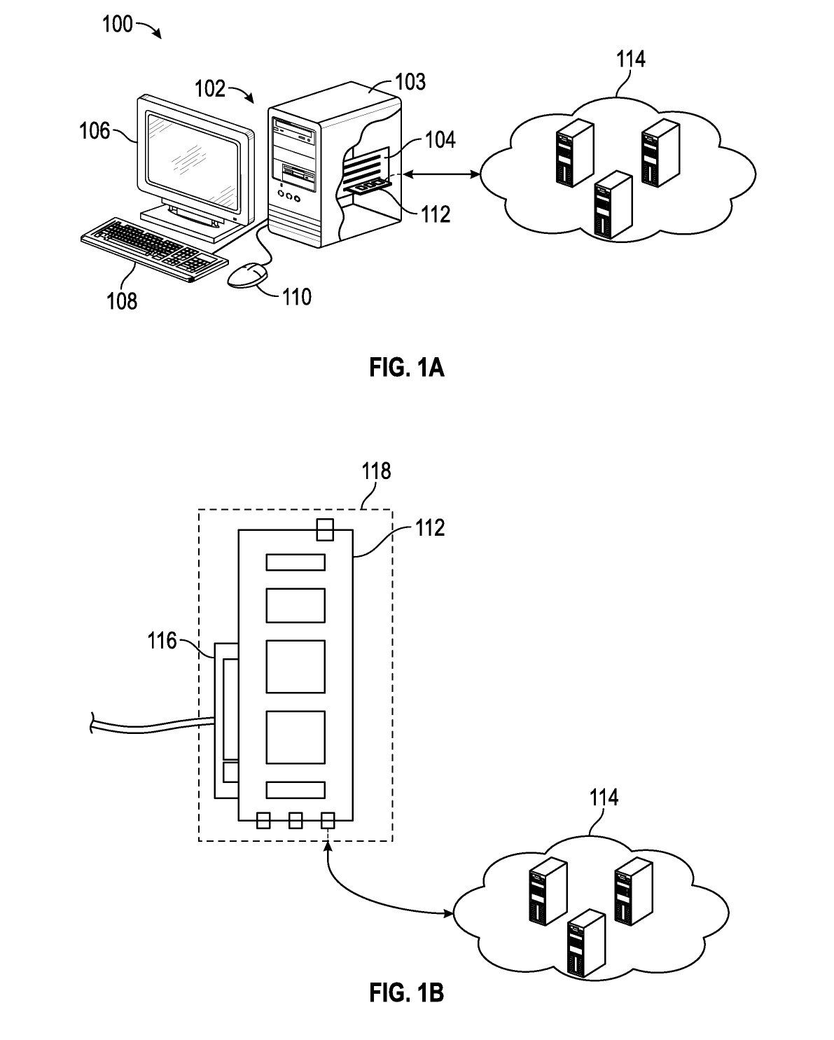

FIG. 1A depicts an angled view of system 100 having a modular computing card configured for operating within a host computer 102, according to one or more embodiments. As depicted, the system 100 generally illustrates the host computer 102 which includes a motherboard 104 arranged within a chassis 103. The host computer 102 further includes various peripheral devices, such as a monitor 106, keyboard 108, and mouse 110, which are communicably coupled to the motherboard 104. The motherboard 104 includes a central processing unit (CPU) (not shown), various forms of volatile and non-volatile memory (not shown), and multiple PCI and PCI-express (PCI-E) slots for additional devices to be communicably coupled to the motherboard 104, thereby enabling increased functionality to the overall system 100.

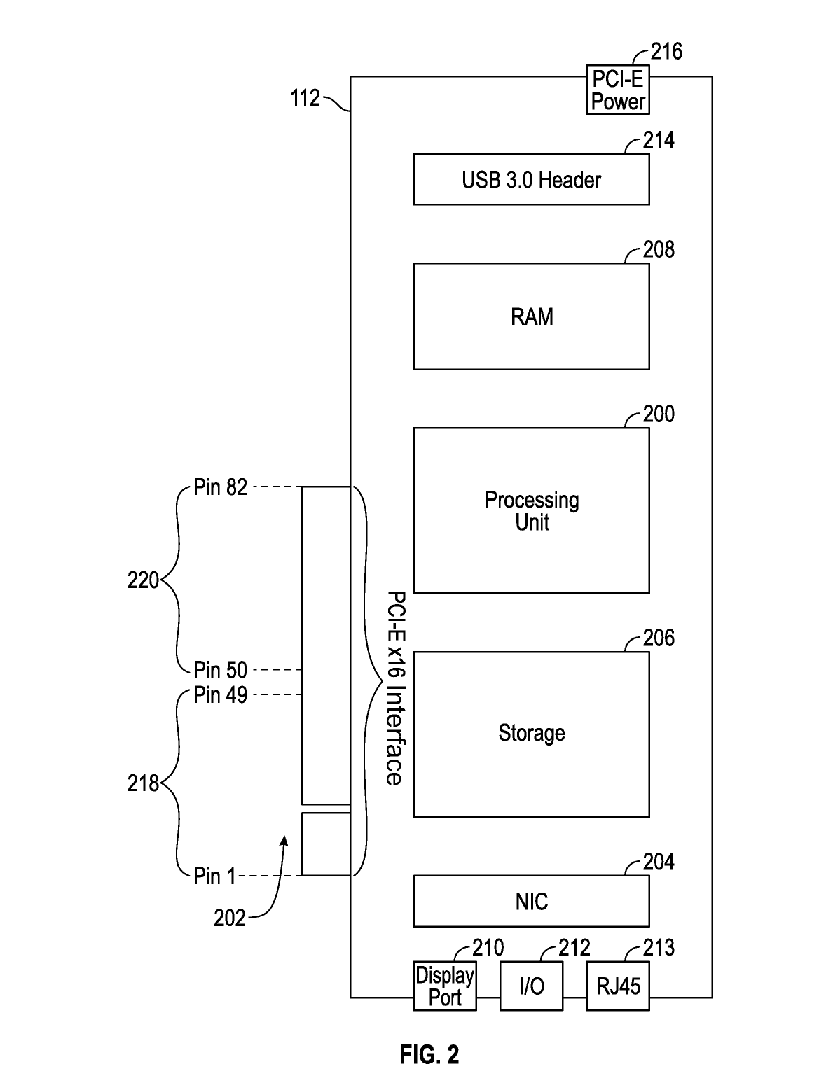

As depicted, a modular computing card 112 is inserted into one of the PCI-E slots of the motherboard 104, thereby receiving power from the motherboard 104 and data from the host computer 102. Discussed in further detail in FIG. 2, the modular computing card 112 is functional computing card which includes a processing unit, an operating system, a memory, input/output (I/O) functionality, and a network interface card (NIC) for interacting with other devices on a network. Therefore, the modular computing card 112 is capable of handling and offloading various tasks from the host computer 102. In particular, the modular computing card 112 may intercept graphics data processing requests or calls from programs running on the host computer 102 and assist with processing such calls. In some embodiments, the modular computing card 112 may process the graphics data locally (via the processor unit). In other embodiments, the modular computing card 112 may offload the request to be processed by an external graphics data processing means, such as servers or, as depicted, a cloud computing network 114 communicably coupled to the modular computing card 112.

In some embodiments, a display means, such as, for example and without limitation, a printer or the monitor 106 may be communicably coupled directly to I/O of the modular computing card 112, and thus the modular computing card 112 may directly output the processed graphics calls thereto. In other embodiments, the modular computing card 112 returns the processed graphics data to the host computer 102 for displaying such.

In further embodiments, such as illustrated in FIG. 1B which depicts a schematic view of the modular computing card 112, according to one or more embodiments, the modular computing card 112 may be configured for operation as a stand-alone computing card. Those skilled in the art will appreciate that the term “stand-alone” computing card may be interpreted in at least the plain and ordinary meaning, but may further include embodiments where, for example and without limitation, an enclosure 118 (e.g., a chassis or the like), encompasses the modular computing card 112. Such may be desirable for, among other reasons: safety, stability, and/or input/output connection expansion. However the modular computing card 112 continues to replace the primary functionality of the motherboard 104 in the previously mentioned host computer.

In FIG. 1B, the modular computing card 112 obtains power via a custom adapter 116 coupled to the PCI-E interface. As the modular computing device includes hardware such as the processing unit, memory, I/O, and an operating system, a program is capable of running directly on the modular computing card 112. As described above (FIG. 1A), the modular computing card 112 is still capable of either processing the graphics data locally (via, for example, the processing unit) or offloading the processing to an external graphics data processing means such as the cloud computing network 114 communicably coupled thereto.

Advantageously, the flexibility of such a modular computing card 112 to run either within a host computer 102, or as a stand-alone unit via power provided through the PCI-E interface and the adapter 116, provides a single low-cost product for the consumer to purchase. The modular computing card 112 can be purchased to increase availability of resources when configured within a host computer 102, including providing resource connectivity to additional external graphics data processing means, or can act alone and still be communicably coupled to the external graphics data processing means.

FIG. 2 is an enlarged schematic view of the modular computing card 112, according to one or more embodiments. As depicted, the modular computing card 112 includes a processing unit 200, a PCI-Express (PCI-E) interface 202, and a network interface means such as a network interface card (NIC) 204 (including associated communication hardware). In some embodiments, the processing unit 200 may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art. Thus, the processing unit 200 may be comprised of a central processing unit (CPU) and an accelerated processing unit (APU) or graphics processing unit (GPU), thereby enabling increased ability to perform graphics processing locally. In further embodiments, the CPU itself may additionally or alternatively include an integrated APU or GPU.

The modular computing card 112, as depicted, further includes various types of memory, such as storage 206. Storage 206 may be any type of memory known to those skilled in the art capable of storing data or executable instructions thereon for a prolonged period of time, and continuing after power to the modular computing card 112 is removed or turned off. Example of such include, without limitation, all variations of non-transitory computer-readable hard disk drives, inclusive of solid-state drives. Other embodiments of the modular computing card 112 may further include random access memory (RAM) 208. RAM 208 may be external to processing unit 200, or in other embodiments be internal (e.g., “on-board” memory) to processing unit 200, and work in coordination with storage 206 to execute programs and/or process graphics data, etc. Example embodiments of RAM may include, without limitation, volatile or non-volatile memory, DDR memory, Flash Memory, EPROM, ROM, or various other forms, or any combination thereof generally known as memory.

The network interface means and NIC 204 may be communicably coupled to additional hardware for performing wired or wireless communications. In some embodiments, where hard-wired network interface means are implemented, the modular computing card 112 may include an RJ45 port 213 communicably coupled to the NIC 204. However, other embodiments may alternatively, or additionally include other network interface means, such as a wireless network interface means (not shown) or plug-in Ethernet card (for wired or wireless communications). Thus, external graphics data processing means may be communicably coupled to the modular computing card 112 via the NIC 204. Such external graphics data processing means may include any variety of graphics data processing hardware, including servers communicably coupled to the modular computing card 112 via LAN or WAN, either hard-wired or wireless, including, for example and without limitation, other computers containing advanced processing graphics cards or hardware, and/or servers and/or a cloud computing system.

In further embodiments, the modular computing card 112 includes additional input and/or output (I/O) and functionality hardware, such as a display port 210 and one or more I/O ports 212. While briefly discussed above, in some embodiments, where the modular computing card 112 is configured as a stand-alone device, the display port 210 may be coupled to a display means, such as monitor 106 (FIG. 1). In other embodiments, where the modular computing card 112 is configured within a host computer, the display port 210 may be employed to output the processed graphics data, but may also be bypassed, wherein the modular computing card 112 transfers the processed graphics data to the host computer via the PCI-E bus for output via a display port of the host computer or a video card.

The I/O ports 212 may be employed to communicably couple any variety of I/O to the modular computing card 112. Example I/O may include, without limitation, user interface I/O, such as a keyboard, a mouse (e.g., PS/2 or USB versions), a printer, a touch device, or any other I/O as known to those skilled in the art. Should USB I/O be employed, the modular computing card 112 may include a USB header 214. As depicted, the USB header 214 is version 3.0, however one of skill in the art will appreciate that any version may be implemented and is contemplated herein.

In further embodiments, the modular computing card 112 includes an additional power source, depicted as PCI-E power 216. As known to those skilled in the art, the PCI-E bus may provide up to approximately 75 watts of power. However, as some embodiments of the modular computing card 112 may employ a processing unit and/or other hardware which may alone or in combination require more than 75 watts, those skilled in the art will appreciate the additional power capable of being provided via the PCI-E power 216.

As known to those skilled in the art, the PCI-E standard allows employing a variety of “lanes” for transfer of data, ranging from 1 lane to 32 lanes. Embodiments contemplated herein may employ any of these varieties without departing from the scope of the disclosure. As depicted in FIG. 2, and primarily discussed herein, a 16 lane or “x16” PCI-E interface 202 and standards are employed. In some embodiments, the PCI-E interface 202 may be utilized in two portions, wherein a first portion of the PCI-E interface is employed when the modular computing card 112 operates within a host computer, and a second portion of the PCI-E interface is employed when the modular computing card 112 operates as a stand-alone computing card. For example, as depicted, the PCI-E interface 202 is virtually divided into a first portion 218, comprised of pins 1 thru 49, and a second portion 220 comprised of pins 50 thru 82. In this embodiment, the first portion 218 is employed (and the second portion 220 is unused) when the modular computing card 112 operates within a host computer, as this requires no alteration to functionality of these pins (pins 1 thru 49). Similarly, the second portion 220 is employed (and the first portion 218 is unused) when the modular computing card 112 operates as a stand-alone computing card. However, functionality of the second portion (pins 50-82) typically used for lanes 9-16 is altered to provide various power and signaling. One exemplary pinout is demonstrated in Table 1 below:

TABLE 1

| Pin # | Side B | Side A | Addition Information |
|---|---|---|---|
| 50 | RESERVED | RESERVED | Reserved - Future Use |
| 51 | PORT1_L | AUDIO_GROUND | HD AUDIO CONNECTOR |
| 52 | PORT1_R | PRESENSE_J | HD AUDIO CONNECTOR |
| 53 | PORT2_R | SENSE1_Return | HD AUDIO CONNECTOR |
| 54 | SENSE_SEND | RESERVED | HD AUDIO CONNECTOR |
| 55 | PORT2_L | SENSE2_RETURN | HD AUDIO CONNECTOR |
| 56 | 5 V | GROUND | LED STATUS POWER (Network) |
| 57 | 5 V | GROUND | LED STATUS POWER (HDD) |
| 58 | 5 V | GROUND | LED STATUS POWER (Power/sleep) |
| 59 | TX+_D1 | TX−_D1 | (RJ45) Transmit Data+/− |
| 60 | RX+_D2 | RX−_D2 | (RJ45) Receive Data+/− |
| 61 | BI+_D3 | BI−_D3 | (RJ45) Bi-Directional |
| 62 | BI+_D4 | BI−_D4 | (RJ45) Bi-Directional |
| 63 | RESERVED | GND_DRAIN | (USB 3.0) Ground for signal return |
| 64 | USB D− | USB D+ | (USB 3.0) USB 2.0 Data |
| 65 | +5 V VBus Power | Ground | (USB 3.0) |
| 66 | StdA_SSRX− | StdA_SSRX+ | (USB 3.0) Superspeed send/receive |
| 67 | StdA_SSRX− | StdA_SSRX+ | (USB 3.0) Superspeed send/receive |
| 68 | DPWR | DGND | (USB 3.0) Power provided by device |
| 69 | RESERVED | GND_DRAIN | (USB 3.0) Ground for signal return |
| 70 | USB D− | USB D+ | (USB 3.0) USB 2.0 Data |
| 71 | +5 V VBus Power | Ground | (USB 3.0) |
| 72 | StdA_SSRX− | StdA_SSRX+ | (USB 3.0) Superspeed send/receive |
| 73 | StdA_SSRX− | StdA_SSRX+ | (USB 3.0) Superspeed send/receive |
| 74 | DPWR | DGND | (USB 3.0) Power provided by device |
| 75 | GROUND | GROUND | |
| 76 | 3.3 V | 3.3 V | Power input/supply |
| 77 | GROUND | GROUND | |
| 78 | 5 V | 5 V | Power input/supply |
| 79 | GROUND | GROUND | |
| 80 | 12 V | 12 V | Power input/supply |
| 81 | 12 V | 12 V | Power input/supply |
| 82 | GROUND | GROUND | |

In exemplary operation, where the modular computing card 112 is configured within a host computer 102, as discussed above, the PCI-E interface 202 is plugged into a PCI-E slot on the motherboard 104 (FIG. 1), enabling transfer of program information and graphics data. A user program is run on the host computer 102. As known to those skilled in the art, the user program generates graphics request calls which include graphics data to be processed. As contemplated here, a graphics intercept, determination, and handling program (hereinafter, “graphics handling program”) is at least partially run on the host computer 102. In some embodiments, a portion of the graphics handling program may also be run on the modular computing card 112. The graphics handling program is capable of intercepting the graphics request from the user program prior to being processed by the host computer. The graphics handling program then transfers the graphics request call and graphics data to the modular computing card 112 for processing. Advantageously, such offloads the request from the host computer, thereby freeing up (or preventing from being used) resources on the host compute now available for other tasks.

The graphics handling program employs predetermined rules for determining the data processing means to be actuated for processing the graphics data, wherein the data processing means is either the processing unit 200 of the modular computing card 112 or an external graphics data processing means communicably coupled to the modular computing card 112 via a network interface means. As described above, such network interface means may include the NIC 204 and associated communication hardware, such as the hard-wired RJ45 port 213 or a wireless communication interface. Further, such external graphics data processing means could be, for example and without limitation, a local server, a server coupled via LAN or WAN, or any cloud computing system.

In one embodiment, the predetermined rules for determining the data processing means include determining the resources available, both internally to the modular computing card 112, and externally. In other words, which external graphics data processing means are communicably coupled to the modular computing card 112, and what their resources capacity and availability is at startup or at a first point in time. For example, whether the cloud computing system 114 (FIG. 1) is communicably coupled (or not) to the modular computing card 112. Additionally, knowledge of whether the modular computing card 112 is arranged within a host computer (e.g., host computer 102) or configured as a stand-alone computing card will alter the resources available for graphics processing. Moreover, determining how much storage 206 and/or RAM 208, and what type of processing power the processing unit 200 is capable of may all be factored in by the graphics handling program and the rules employed to determine which data processing means to actuate. In further embodiments, additionally, beyond initial knowledge of resources available, the graphics handling program may continuously monitor such resources and make decisions based on resource availability.

In some embodiments, such rules may determine an average amount of time to process at least a portion of the graphics data. For example, the modular computing card 112 may attempt to process the graphics data locally via the processing unit 200. However, if such processing consistently takes longer than a predetermined amount of time (e.g., 5 milliseconds (ms) or 10 ms), the modular computing card 112 may revert to offloading the entire graphics data to be processed by the external graphics data processing means (e.g., the cloud computing network). If such is a continuing reoccurrence, in other embodiments, the modular computing card 112 may store the use program being run into a list of predefined or user-defined programs which employ only the external graphics data processing means, thereby preventing future initial delays. Similarly, and in further embodiments, the predetermined rules may comprise a predetermined list of applications which are known to require graphics processing beyond the capabilities of the processing unit 200, and therefore will always require processing by the external graphics data processing means.

Upon the determination of which graphics data processing means to be actuated, the modular computing card 112 actuates such means as necessary according to the graphics data requests and graphics data to be processed. Where the external graphics data processing means is actuated, in some embodiments, such means may include a corresponding portion to, or an extension of, the graphics handling program instructing the data processing means how to handle the graphics data processing requests and/or graphics data. For example, the external graphics data processing means may include software manufactured by the same company whose software runs on the modular computing card 112, thereby ensuring accuracy of handshaking and hardware communications.

In other embodiments, the external graphics data processing means may include third-party software capable of receiving and processing the graphics data. Upon completion of the graphics processing, if the processing was performed via external graphics data processing means, the processed graphics is returned to the modular computing card 112. As known to those skilled in the art, such may be in the form of compressed data, or in other embodiments, an image stream of the processed graphics data.

Thereafter, the resulting data or image stream is output via a display means communicably coupled to the modular computing card 112. Such display means may be the display port 210 of the modular computing card 112. In other embodiments, the modular computing card 112 transfers the processed graphics data back to the host computer 102 for display, for example, via the monitor 106 (FIG. 1).

In other embodiments, where the modular computing card 112 is configured as a stand-alone computing card, workings and functionality are substantially similar. However, a custom power connector may be coupled to the PCI-E interface 202, wherein the second portion 220 is employed to power and provide certain signals to the modular computing card 112. In such embodiments, the user program and the graphics handling program are both stored on the storage 206 and/or RAM 208 and executed by the processing unit 200. Some or all of the same or similar rules discussed herein may be employed by the modular computing card 112 to determine which graphics data processing means should be employed.

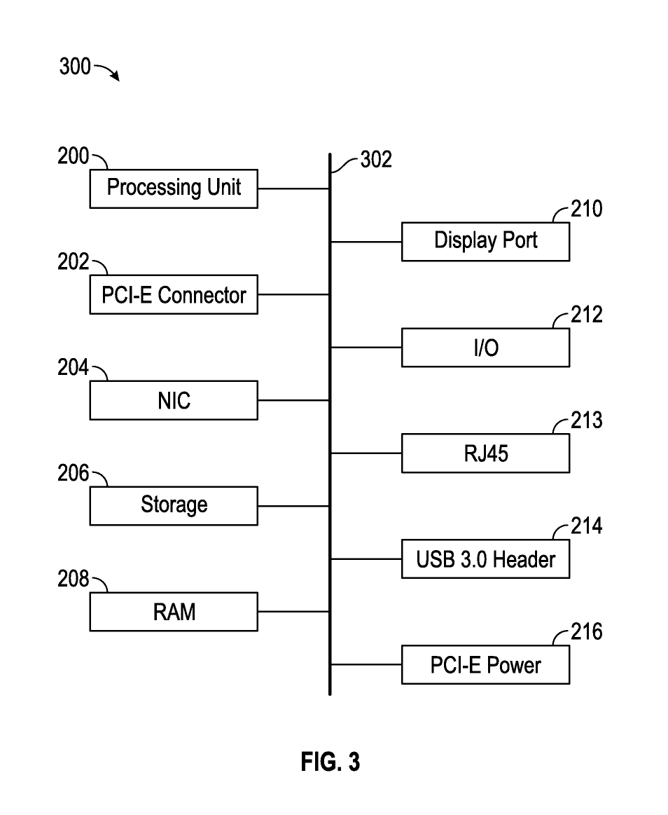

FIG. 3 is a block diagram 300 of the modular computing card components, according to one or more embodiments. As depicted, the diagram 300 illustrates various components of one embodiment of the modular computing card 112. Such components include the processing unit 200, the PCI-E interface 202, the NIC 204, and the storage 206 and RAM 208. Further components depicted are the display port 210, I/O port(s) 212, RJ45 port 213, and USB header 214.

The diagram 300 exhibits how some or all of the components of an embodiment of the modular computing card 112 (FIG. 2) may be communicably coupled together via a central bus 302. However, those skilled in the art will appreciate, and it is contemplated herein, that multiple busses may be employed, each bus communicably coupling two or more components together, and each component may be coupled to more than one bus 302. Each component may be any variation of those previously described and discussed herein.

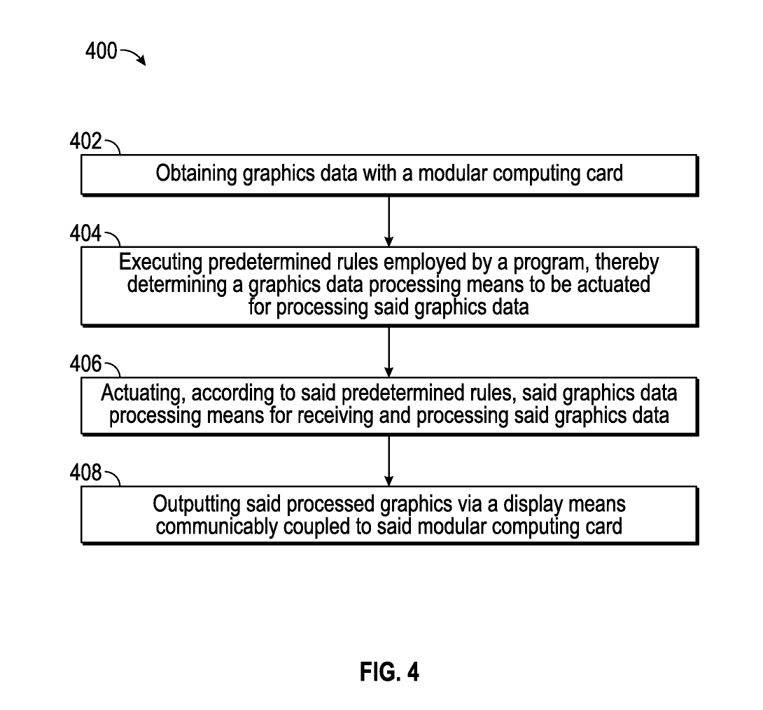

FIG. 4 is a flow diagram of an illustrative method 400 for performing graphics processing, according to one or more embodiments. The method 400 may be implemented by one or more embodiments of the systems discussed above and disclosed herein. At block 402, the method 400 obtains graphics data with a modular computing card, wherein the modular computing card comprises a processing unit, a PCI-Express (PCI-E) interface, and a network interface means. In some embodiments, the processing unit may be similar to processing unit 200, and thus may be comprised of a central processing unit (CPU) and an accelerated processing unit (APU), thereby enabling increased ability to perform graphics processing locally. In further embodiments, the CPU itself may additionally or alternatively include an integrated APU. The PCI-E interface may employ any number of “lanes” as accepted under the PCI-E standard, ranging from 1 to 32 lanes. The network interface means may employ a network interface card (NIC) (e.g., NIC 204) and additional hardware as necessary for networking communications, such as required for wired and/or wireless communications.

The modular computing card is configured for operating within a host computer via the PCI-E interface, and also configured for operating as a stand-alone computing card via power through the PCI-E interface. Advantageously, such enables employment of the modular computing card to enhance a host computers operating capabilities, but may also be a low-cost solution to consumers or businesses looking for a lower cost stand-alone solution which can readily access external graphics data processing resources if necessary.

At block 404, the method 400 executes predetermined rules employed by a graphics handling program, thereby determining a graphics data processing means to be actuated for processing the graphics data. The graphics data processing means is one of the modular computing card processing unit or an external graphics data processing means communicably coupled to the modular computing card via the network interface means previously discussed.

In one embodiment, the predetermined rules for determining the data processing means include determining the resources available, both internally to the modular computing card, and externally. In other words, which external graphics data processing means are communicably coupled to the modular computing card, and what their resources capacity and availability is at startup or at a first point in time. For example, whether the cloud computing system is communicably coupled (or not) to the modular computing card. Additionally, knowledge of whether the modular computing card is arranged within a host computer or configured as a stand-alone computing card will alter the resources available for graphics processing. Moreover, determining how much storage and/or RAM, and what type of processing power the processing unit is capable of may all be factored in by the graphics handling program and the rules employed to determine which data processing means to actuate. In further embodiments, additionally, beyond initial knowledge of resources available, the graphics handling program may continuously monitor such resources and make decisions based on resource availability.

In some embodiments, such rules may determine an average amount of time to process at least a portion of the graphics data. For example, the modular computing card may attempt to process the graphics data locally via the processing unit. However, if such processing is consistently takes longer than a predetermined amount of time (e.g., 5 milliseconds (ms) or 10 ms), the modular computing card may revert to offloading the entire graphics data to be processed by the external graphics data processing means (e.g., the cloud computing network). If such is a continuing reoccurrence, in other embodiments, the modular computing card may store the use program being run into a list of predefined or user-defined programs which employ only the external graphics data processing means, thereby preventing future initial delays. Similarly, and in further embodiments, the predetermined rules may comprise a predetermined list of applications which are known to require graphics processing beyond the capabilities of the processing unit, and therefore will always require processing by the external graphics data processing means.

At block 406, the method 400 actuates, according to the predetermined rules, the graphics data processing means for receiving and processing the graphics data. Thus, the graphics data may be processed either by the processing unit of the modular computing card, or by an external graphics data processing means.

At block 408, the method 400 outputs the processed graphics via a display means communicably coupled to the modular computing card. If the modular computing card is configured within a host computer, the processed graphics (in some embodiments, being processed by the processing unit; in other embodiments, being received back from the external graphics data processing means) may be output via a display port of the modular computing card. In other embodiments, the processed graphics are returned to the host computer via the PCI-E bus for display. If the modular computing card is configured as a stand-alone computing card, the processed graphics are displayed via a display port of the modular computing card.

Although the disclosure has been described and illustrated with respect to exemplary objects thereof, it will be understood by those skilled in the art that various other changes, omissions, and additions may be made therein and thereto without departing from the scope of the present disclosure.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed.

Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method for performing graphic processing, comprising:
obtaining graphics data with a modular computing card, said modular computing card comprising a processing unit, a PCI-Express interface, and a network interface means,
wherein said modular computing card is configured for operating within a host computer via said PCI-Express interface, and also configured for operating as a stand-alone computing card via power through said PCI-Express interface;
executing predetermined rules employed by a program, thereby determining a graphics data processing means to be actuated for processing said graphics data,
wherein said graphics data processing means is one of said processing unit or an external graphics data processing means communicably coupled to said modular computing card via said network interface means;
actuating, according to said predetermined rules, said graphics data processing means for receiving and processing said graphics data; and
outputting said processed graphics via a display means communicably coupled to said modular computing card.

2. The method of claim 1, wherein a first portion of said PCI-Express interface is employed when said modular computing card operates within said host computer, and a second portion of said PCI-Express interface is employed when said modular computing card operates as said stand-alone computing card.

3. The method of claim 1, wherein when said modular computing card is configured for operating within said host computer, said program is executed at least partially by said host computer.

4. The method of claim 3, wherein said display means comprises a display communicably coupled to a display output of said host computer.

5. The method of claim 1, wherein said predetermined rules comprises determining an average amount of time to process at least a portion of said graphics data.

6. The method of claim 1, wherein said predetermined rules comprise monitoring availability of resources on said modular computing card.

7. The method of claim 1, wherein said predetermined rules comprise determining if said external graphics data processing means are available.

8. The method of claim 6, wherein said external graphics data processing means are a cloud computing system.

9. The method of claim 1, wherein said predetermined rules comprise a predetermined list of applications which employ only said external graphics data processing means.

10. The method of claim 1, wherein said predetermined rules comprise a user determined list of applications which employ only said external graphics data processing means.

11. A system for performing graphics processing, comprising:
a modular computing card configured to obtain graphics data and comprising a processing unit, a PCI-Express interface, and a network interface means,
wherein said modular computing card is configured for operating within a host computer via said PCI-Express interface, and also configured for operating as a stand-alone computing card via power through said PCI-Express interface;
a graphics data processing means, wherein said graphics data processing means is one of said processing unit or an external graphics data processing means communicably coupled to said modular computing card via said network interface means;
a program configured to execute predetermined rules, thereby determining said graphics data processing means to be actuated for processing said graphics data; and
a display means communicably coupled to said modular computing card for outputting said processed graphics.

12. The system of claim 11, wherein a first portion of said PCI-Express interface is employed when said modular computing card operates within said host computer, and a second portion of said PCI-Express interface is employed when said modular computing card operates as said stand-alone computing card.

13. The system of claim 11, wherein when said modular computing card is configured for operating within said host computer, said program is executed at least partially by said host computer.

14. The system of claim 11, wherein said PCI-Express interface is a 16 lane interface.

15. The system of claim 11, wherein said processing unit is comprised of a central processing unit (CPU) and an accelerated processing unit (APU).

16. The system of claim 11, wherein said modular computing card further comprises a display port, an Input/Output port, and an auxiliary power port.

17. The system of claim 11, wherein said network interface means is a hard-wired means.

18. The system of claim 11, wherein said network interface means is a wireless means.
